(19) United States
(12) Patent Application Publication
(10) Pub. No.: US 2020/0134605 A1
(43) Pub. Date: Apr. 30, 2020

(54) CUSTOMIZABLE PAYMENT SYSTEMS, DEVICES, AND METHODS, AND VISUALIZATION THEREOF

(71) Applicants: Evita V. Grant, Mountain View, CA (US); Christina Susanto, Palo Alto, CA (US)

(72) Inventors: Evita V. Grant, Mountain View, CA (US); Christina Susanto, Palo Alto, CA (US)

(21) Appl. No.: 16/171,367

(22) Filed: Oct. 26, 2018

(51) Int. Cl. G06Q 20/34; G06Q 30/02

(52) U.S. Cl. CPC G06Q 20/351; G06Q 30/0215

(57) ABSTRACT

Provided herein are payment systems, methods, and devices with customizable features. A user may select, modify, or remove one or more features from a payment system, method, and/or device. In some instances, the selected features may be visible to the user on the payment medium or instruments. The payment medium may be tangible, such as in the form of a card or other plastic material. The payment medium may be virtual, and accessible via one or more user devices via a user interface. For example, the user interface can be a graphical user interface (GUI) and/or a web-based interface. The payment system may be a mobile payment system.

### CROSS-REFERENCE

This application claims the benefit of U.S. Provisional Patent Application No. 62/577,169, filed Oct. 26, 2017, which application is entirely incorporated herein by reference.

### BACKGROUND

Financial transactions can be facilitated via cards. A card may be preferable over cash-based transactions, check-based transactions, or other paper-based transactions, for example, for its portability and security. For example, any balance may be carried on a single card as opposed to varying paper volume. The same card may be used any number of times without having to exchange physical material. Risk of human error (e.g., counting, mathematical computations) during financial transactions can be also be reduced. Furthermore, a card may carry security features unavailable with cash. A card may be associated with a user, and protected by passwords, such as a PIN A card may be disabled or canceled remotely upon loss or theft, unlike with cash to prevent further loss.

### SUMMARY

Cards can have various additional features, such as particular discounts, particular rewards, particular security programs, and other features. However, a card may often have features that a user does not desire but is nonetheless charged (e.g., by monthly fee). Cards with features that a user does desire may be unavailable to the user, for example, for lack of supply or the user's lack of credit to qualify for such cards. Thus, recognized herein is a need for customizable payment systems, devices, and methods. Furthermore, unlike with cash, where available balance is readily visible (or rather, countable), it is oftentimes difficult to verify the balance of available financial credit with a card. Recognized herein is a need for visual systems, devices, and methods for facilitating card transactions. The systems, devices, and methods described herein may address at least the aforementioned problems.

Provided herein are payment systems, such as cards, with customizable features. A user may select, modify, or remove one or more features from a payment system. In some instances, the selected features may be visible to the user on the payment medium. The payment medium may be tangible, such as in the form of a card or other plastic material. The payment medium may be virtual, and accessible via one or more user devices via a user interface. For example, the user interface can be a graphical user interface (GUI) and/or a web-based interface. The payment system may be a mobile payment system.

The user may be provided with a display of the balance of available financial credit associated with the card. For example, the available financial credit may be available credit on a credit card, available account balance on a debit card, available prepaid balance on a credit card, available rewards or points balance on a rewards card, and/or other types of financial credit on other types of cards. The display can be integrated in the card. The display can be a user interface, such as a graphical user interface (GUI). The available balance on the display can be updated periodically or manually, such as with each card transaction. The available balance on the display can be updated, such as via connection with a device, such as a mobile device, other personal device, or purchase processing device.

In an aspect, provided is a card, comprising one or more customizable features selected by a user, wherein the one or more customizable features (1) define the financial capabilities of the card, and (ti) are selected from the group consisting of: single-use, reloadable, international, domestic, direct deposit, reward, gift, shared, savings, elder support, and allowance.

In some embodiments, the one or more customizable features are displayed on the face of the card.

In some embodiments, the one or more customizable features can be modified.

In another aspect, provided is a virtual payment system, comprising a graphical user interface displaying a virtual card, wherein the virtual card comprises graphical representations of one or more customizable features selected by a user, wherein the one or more customizable features (i) define the financial capabilities of the virtual card, and (ii) are selected from the group consisting of: single-use, reloadable, international, domestic, direct deposit, reward, gift shared, savings, elder support, and allowance.

In some embodiments, the one or more customizable features can be modified.

In some embodiments, the system further comprises a tangible card associated with the virtual card, wherein the tangible card comprises the one or more customizable features selected by the user.

In some embodiments, the system further comprises a display window, wherein the graphical user interface is communicatively coupled to a processor capable of obtaining information about financial credit associated with the virtual card, and wherein the display window is configured to show the information about the financial credit associated with the virtual card. In some embodiments, the virtual card is a prepaid card and the information about the financial credit associated with the virtual card is an available balance of the virtual card. In some embodiments, the information about the financial credit associated with the virtual card is selected from the group consisting of available balance, amount spent, rewards accumulated, and rewards spent. In some embodiments, the system further comprises a plurality of display windows, wherein each of the plurality of display windows shows a different type of information about the financial credit associated with the virtual card.

In another aspect, provided is a method for creating a virtual card, comprising: (a) presenting a user, on a graphical user interface, with a graphical representation of the virtual card and an option menu comprising graphical representations or textual representations or both of a plurality of customizable features, wherein the plurality of customizable features define the financial capabilities of the virtual card; (b) receiving, from the user, a selection for a subset of the plurality of customizable features; and (c) displaying the respective graphical representations of the subset of the plurality of customizable features on the graphical representation of the virtual card.

In some embodiments, the plurality of customizable features are selected from the group consisting of single-use, reloadable, international, domestic, direct deposit, reward, gift, shared, savings, elder support, and allowance.

In some embodiments, the respective graphical representations of the subset of the plurality of customizable features are displayed on the graphical representation of the virtual card in real-time as the selection is received from the user. In some embodiments, the graphical representation of the virtual card is updated in real-time with each selection of each of the subset of the plurality of customizable features.

In some embodiments, the method further comprises receiving, from the user, a modification to the selection for the subset, and updating the graphical representation of the virtual card with the modification. In some embodiments, the modification comprises adding or removing a customizable feature to or from the subset.

In some embodiments, the method further comprises issuing a tangible card associated with the virtual card, wherein the tangible card comprises the subset of the plurality of customizable features.

In some embodiments, the graphical representation of the virtual card comprises a display window showing information about a financial credit associated with the virtual card. In some embodiments, the virtual card is a prepaid card and the information about the financial credit associated with the virtual card is an available balance of the virtual card. In some embodiments, the information about the financial credit associated with the virtual card is selected from the group consisting of available balance, amount spent, rewards accumulated, and rewards spent.

In some embodiments, the option menu further comprises options for setting or modifying one or more visual parameters of the virtual card or an element thereof, and the method further comprises receiving a user command for setting or modifying at least one visual parameter of the virtual card or the element thereof, and updating the graphical representation of the virtual card with the user command. In some embodiments, the one or more visual parameters comprises colors, shapes, forms, background images, or sizes for the virtual card. In some embodiments, the graphical representation of the virtual card is updated in real-time with receipt of the user command.

In another aspect, provided is card, comprising a card substrate, a chip comprising an integrated circuit comprising a memory, the chip embedded in the card substrate; and a display embedded in the card substrate, wherein the display is communicatively coupled to the chip, wherein the display is configured to show information about financial credit associated with the card.

In some embodiments, the display is a graphical user interface (GUI). In some embodiments, the display is configured to show an available balance of the card.

In another aspect, provided is a virtual payment system, comprising a graphical user interface displaying a virtual card, wherein the virtual card comprises a card display window, wherein the graphical user interface is communicatively coupled to a processor capable of obtaining information about financial credit associated with the virtual card, and wherein the display is configured to show the information about the financial credit associated with the virtual card.

In some embodiments, the information about the financial credit associated with the virtual card is an available balance of the virtual card.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a card-based payment system with selectable features.

FIG. 2 shows an example of a virtual card-based payment system with selectable features.

FIG. 3 shows an example of a card with a display.

FIG. 4 shows an example of a virtual card with a display.

FIG. 5 shows a computer system that is programmed or otherwise configured to implement systems, devices, and methods of the present disclosure.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Provided herein are payment systems, methods, and devices with customizable features. A user may select, modify, or remove one or more features from a payment system, method, and/or device. In some instances, the selected features may be visible to the user on the payment medium. The payment medium may be tangible, such as in the form of a card or other plastic material. The payment medium may be virtual, and accessible via one or more user devices via a user interface. For example, the user interface can be a graphical user interface (GUI) and/or a web-based interface. The payment system may be a mobile payment system.

A payment system, device, and/or method of the present disclosure may involve a fund transfer. The fund transfer can be a payment, such as from a buyer to a seller or customer to a merchant. The fund transfer can be a bill payment. The fund transfer can be a gift, such as from a first user to a second user. The fund transfer can be a refund. The fund transfer can be a peer-to-peer (P2P) transfer. The fund transfer can be a direct deposit. The fund transfer can be a push transaction, originating from the sending financial institution. The fund transfer can be a pull transaction, originating from the receiving financial institution.

The fund transfer can be from a first financial account to a second financial account. A financial account may be associated with a financial institution. For example, the fund transfer can be from a first financial institution to a second financial institution. In other instances, the fund transfer can be within one financial institution, such as from a first financial account of the financial institution to a second financial account of the financial institution. In some instances, a financial account may be owned and/or managed by a single user. In some instances, a financial account may be shared. For example, the financial account may be owned by a plurality of users (e.g., as joint ownership, etc). In another example, the financial account may be managed by a plurality of users. A user may be any individual, group of individuals, entity, or group of entities capable of owning and/or managing a financial account.

The fund transfer can be a domestic transfer. The fund transfer can be an international transfer. The fund transfer can be over a network, such as an electronic banking network, and/or intermediary funds system. The fund transfer can be over an automated clearing house (ACH) system. For example, the fund transfer can be over the Fedwire®, Clearing House Interbank Payments System (CHIPS), Society for Worldwide Interbank Financial Telecommunication (SWIFT), and other systems. The fund transfer can be facilitated by mail, electronic mail (e-mail), facsimile, telephone, telex, text messages, and/or any other networks.

A financial institution may be a bank. A financial institution may be a deposit-taking institution and/or a credit-taking institution, such as a bank, credit union, trust company, loan (e.g., mortgage, auto, etc.) company, and/or building society. A financial institution may be a contractual institution, such as an insurance company or pension fund. A financial institution may be an investment institution, such as a brokerage company, underwriter, or investment company. A financial institution may be any individual or entity providing financial services, such as saving, investing, risk pooling, pawning, check cashing, exchanging (e.g., currency, credit, etc.), loaning, micro-loaning, paying, credit-issuing, brokering, fund settling, or any other financial services. Any description of a bank herein may apply to any other type of financial institution, and vice versa.

The payment systems, methods, and devices described herein may be associated with one or more financial institutions. The payment systems, methods, and devices described herein may be applicable to one or more financial institutions. The payment systems, methods, and devices described herein may be issued by one or more financial institutions.

A payment system of the present disclosure can be a card-based system. For example, a payment device of the present disclosure can comprise a tangible card. A payment device of the present disclosure can comprise a virtual card, which can be accessible, for example, via a user device having a user interface (e.g., GUI). The payment system can be a mobile payment system. The payment system may be remotely accessible. The payment system can be a prepaid card system.

In some instances, a payment system of the present disclosure can be a non-card-based system. For example, a payment device may comprise a code (e.g., barcode, quick response (QR) code, 1-Dimensional (1D) code, 2-Dimensional (2D) code, 3-Dimensional (3D) code, text code, or any graphical code, etc.) accessible via a user device. A payment device may comprise a link, such as a hyperlink (e.g., URL) accessible via a user device. A payment device may comprise an address, such as a telephone number (e.g., mobile phone number, home phone number), facsimile number, mailing address, electronic mail (e-mail) address, and other types of addresses accessible via a user device. In some instances, the payment system may be facilitated via text messaging. In some instances, the payment system may be embodied in a source (or origin) and/or destination of a fund transfer, such as in the financial account from or to which the transfer is happening.

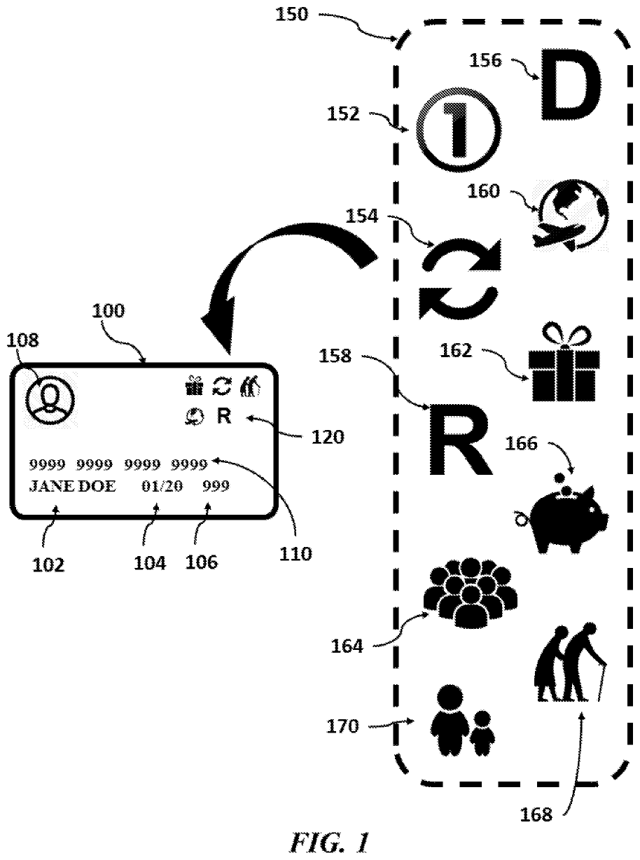

FIG. 1 shows an example of a card-based payment system with selectable features. A card 100 can be a prepaid card. A prepaid card may be associated with positive financial credit. The card 100 may or may not have a unique financial account (e.g., bank account) associated with the card 100. In some instances, a plurality of cards (e.g., including the card 100) may be associated with the same financial account. In some instances, the card 100 may be associated with a plurality of financial accounts.

The card 100 can have standard card dimensions, for example, complying with international standards (e.g., ISO/IEC 7810). For example, the card can be 85.60 millimeters (mm) in length, 53.98 mm in width, and 0.76 mm in thickness. Alternatively, the card can have any size. Preferably, the card can fit in a wallet or purse.

The card 100 may have one or more security identification features 108. The security identification features 108 can be, for example, a picture of the owner of the card 100. The security identification features 108 can comprise any other graphic, such as a photo, picture, symbol, image, and/or combination thereof. The security identification features 108 can comprise text, such as a name or nickname of the card 100 and/or the owner of the card 100. The security identification features 108 can comprise both graphic and text. The security identification features 108 may provide validation or verification regarding proper ownership of the card. For example, the security identification features 108 may allow for the verification of the user of the card 100 as someone or some entity having authority to use the card 100 (e.g., at a vendor). The security identification features may facilitate identification of the card 100 to the owner, user, and/or manager of the card 100. The one or more security identification features 108 may be printed on the card 100. The one or more security identification features 108 may be embossed, embedded, and/or otherwise imprinted on the card 100. Alternatively, the card 100 may not have any security identification features 108. Any of the features mentioned herein, such as described above or further below, may be on the front side and/or back side of the card 100.

The card 100 may have a name 102 of the user, owner, and/or manager of the card 100. The name 102 may be printed on the card 100. The name 102 may be embossed, embedded, and/or otherwise imprinted on the card 100. The card 100 may have an expiration date 104. The expiration date 104 may be printed on the card 100. The expiration date 104 may be embossed, embedded, and/or otherwise imprinted on the card 100. The card 100 may have a card verification value (CVV) 106 or other security code of the card 100. The CVV 106 may be printed on the card 100. The CVV 106 may be embossed, embedded, and/or otherwise imprinted on the card 100. The card 100 may have a card number 110 or identification or other security code of the card 100. The card number 110 may be printed on the card 100. The card number 110 may be embossed, embedded, and/or otherwise imprinted on the card 100.

A user may customize one or more features 150 on the card 100. A user can be an owner of the card 100. A user can be a creator of the card 100. A user can be a recipient of the card 100. A user can be any individual or entity, or group of individuals or group of entities, managing, using, and/or otherwise controlling the card 100 by at least some amount.

The customizable features 150 may affect the functionality of the card 100. The customizable features 150 may define the financial capabilities of the card 100. Customizable features 150 may include, for example, but are not limited to, single load 152, reloadable 154, direct deposit 156, reward 158, international 160, domestic (not shown in FIG. 1), gift 162, shared 164, savings 166, elder support 168, and allowance 170. Some customizable features may be mutually exclusive, such as single load 152 and reloadable 154 or international 160 and domestic. Some features may be combined with other features. A user may select any combination of customizable features available for selection that is not mutually exclusive. In some instances, depending on the selection of customizable features, creation of the card 100 may or may not be accompanied by creation of a financial account (e.g., debit account, deposit account, etc.). In some instances, depending on the selection of customizable features, creation of the card 100 may or may not require a credit evaluation. In some instances, depending on the selection of customizable features, creation of the card 100 may or may not require the user and/or creator of the card to provide personal information (e.g., name, address, phone number, social security number, etc.). For example, the creation of a financial account, credit evaluation, and the provision of personal information may be secondary considerations when the user is selecting the customizable features.

Personal information that can be requested from the user can include Know-your-customer (KYC) information. KYC information can include, for example, name, address, an identification number (e.g., social security number, government identification number, tax identification number, passport number, etc.), and one or more identification documents (e.g., photo ID, driver's license, student license, passport, etc.).

A single load 152 feature can allow the card 100 to be loaded once at the creation of the card and not thereafter. For example, a card with the single load 152 feature can expire or otherwise become valueless after the initial load is spent. A card may be loaded with, for example, value, currency, cryptocurrency, or any other financial credit. Creation, and loading, of the card can be simple and convenient relative to, for example, reloadable 154 cards. For example, in some instances, no personal information (e.g., name, social security number, etc.) may be required from the creator of the card having the single load 152 feature.

A reloadable 154 feature can allow the card 100 to be loaded more than once. A user may load the card 100 with any frequency. A user may load the card 100 at any time. In some instances, a reloadable card may never expire.

A direct deposit 156 feature can allow the card 100 to receive direct deposits. For example, a card having the direct deposit feature may be capable of receiving direct deposits of pay, salary, monthly social security benefits, tax refunds, pensions, unemployment benefits, disability benefits, veterans' benefits, other benefits, and/or other sources of income. A debit account can be associated with the card. In some instances, a debit account can be created and associated with the card. In some instances, an existing debit account can be associated with the card. In some instances, selection of this feature can prompt the user to provide personal information required to create the debit account or provide information about pre-existing debit accounts.

A reward 158 feature can allow the card 100 to collect rewards with use of the card 100. The rewards can be points. The rewards can have monetary value. The rewards can be financial credit (e.g., currency, cashback). The rewards can be any credit. The rewards can be in the form of discounts. In some instances, the rewards can be redeemable as money. In some instances, the rewards can be redeemable as prizes or purchases. In some instances, the card 100 may collect rewards based on transactions made using the card 100, such as the frequency of transactions, type of transaction, or the value of the transactions. In some instances, the card 100 may collect rewards based on passage of time since creation and/or use of the card 100. The card 100 may collect rewards based on any other standard. In some instances, the rewards may be used with select merchants and/or with select activities.

An international 160 feature can allow the card 100 to be used in larger geographic scope. For example, the card may be used in a plurality of countries. The card may be used outside the sovereign state in which the card was created. In some instances, the user may select the locations in which the card 100 is usable. In some instances, the card may be used in all locations (e.g., any location). In some instances, the card having the international feature may offer discounts for international transactions (e.g., card transactions made in foreign states). In some instances, the card may allow international transactions to be conducted in an international currency (e.g., as opposed to domestic currency). The international currency, for example, may be determined by country code.

A gift 162 feature can allow the card 100 to be created on behalf of another user or for the benefit of another user. In some instances, a gift card may only be used in designated locations, such as with designated merchants. For example, a gift card may be used in with only one designated merchant. In some instances, a user may be able to designate the locations in which the gift card is usable. In other instances, a gift card may be used without limitation of locations and/or merchants. In some instances, a user creating the card may maintain control of the card, such as even after having gifted the card to a recipient user. In some instances, a user creating the card may surrender control to the recipient user upon gifting.

A shared 164 feature can allow the card 100 to be shared between a plurality of users. For example, all shared users may be able to use the card independently, such as to conduct transactions (e.g., purchases, P2P transfers, cash withdrawal, etc.). In some instances, a single card may be shared between a plurality of users. In some instances, each shared user may be provided with a duplicate copy of the card. In some instances, each shared user may be provided with secondary cards associated with a shared primary card. In some instances, each shared user may be provided with a unique card, each associated with the card 100.

In some instances, shared users may be divided into primary user(s) and secondary user(s). A primary user may exercise more control over the card than a secondary user. For example, a primary user may be able to designate, modify, and/or remove the users sharing the card. A primary user may be able to set spending limits of a particular shared user. A primary user may be able to convert a primary user to a secondary user or vice versa. Other tiers of control may be available (e.g., tertiary, quaternary, etc). The categorization of control described herein are exemplary.

The users sharing a shared card may be fixed, such as upon creation. For example, the users sharing the card may not thereafter be added, removed, or otherwise modified. Alternatively, the users sharing a shared card may be added, removed, or otherwise modified after creation.

In some instances, all the users sharing a shared card may exercise equal control over the card. Alternatively, different shared users may exercise different levels of control, such as described above. For example, some shared users may be limited in the type of card transactions available (e.g., P2P transfer, purchase, cash withdrawal, direct deposit, etc.). In another example, some shared users may have different spending limits. In another example, some shared users may be able to deposit funds into the card. In another example, some shared users may be able to modify the shared users. In another example, some shared users may be able to modify the different levels of control between users. In another example, some shared users may be able to add, modify, or remove other features to the card. In another example, some shared users may be able to terminate the card.

A savings 166 feature can allow a user to save funds into the card 100. In some instances, the card may collect interest on the saved finds. In some instances, the savings feature can allow the user to transfer some amount of funds (e.g., change to the nearest dollar, etc.) to a savings account. The savings account can be associated with the card. In some instances, the savings account can be linked to investment or retirement accounts. In some instances, the savings account can be created and associated with the card. In some instances, a pre-existing savings account can be associated with the card. In some instances, selection of the savings feature can prompt the user to provide personal information required to create a savings account and/or information about the pre-existing saving account. In some instances, a savings card may allocate a portion of the funds associated with the card as savings funds and disallow a user from transferring funds from the savings funds.

An elder support 168 and/or allowance 170 feature can allow the card 100 to be created on behalf of another user or for the benefit of another user. For example, the card can have a supporting user and a supported user, and/or a plurality of either or both. The card may be created by either or both the supporting user and the supported user. For example, a card created by a supporting user can allow the supporting user to designate one or more supported users. A card created by a supported user can allow the supported user to designate one or more supporting users. In some instances, the supporting user and the supported user can share the same card. In some instances, the supporting use and the supported user can each have different cards that are associated with the other.

The supporting user and the supported user can exercise the same or different control over the card 100. In some instances, the supporting user can provide the funds for the card, such as for use by the supported user. The card may receive the funds on a periodic basis, for example, as a monthly allowance. The card may receive the funds as a direct deposit. The card may receive the funds on an arbitrary basis, at the freedom and/or control of the supporting user. In some instances, the supported user may prompt the supporting user to provide the funds, such as by sending a request (e.g., over a network).

The elder support 168 feature may allow a supporting user to monitor activity of the card by the supported user, such as a transaction history. In some instances, the elder support card may not have a supporting user, and the activity of the card may be monitored by a third party, such as an administrator, manager, or issuer (e.g., financial institution, financial intermediary) of the card with special attention. Beneficially, the elder support 168 can be selected for users more vulnerable to fraud and monitored with elevated surveillance for fraudulent activity. While the feature is called elder support, the user base is not limited to the elderly, and a user of any age base (e.g., minors, etc.) may select this feature. Any user that desire elevated surveillance may select this feature.

The allowance 170 feature may allow a supporting user to monitor activity of the card by the supported user, such as a transaction history. In some instances, the supporting user may be a parent, trustee, or other guardian of a supported user (e.g., minor, children, etc.). The supporting user may be able to exercise elevated oversight (e.g., parental oversight) over the spending of the supported user.

A currency feature (not shown in FIG. 1) may allow a user to select a currency (e.g., USD) of the card. In some instances, a user may select a plurality of currencies. For example, the user may select a currency in which the card transaction is conducted. The user may select a currency in which the funds are saved or otherwise stored. The user may select a currency in which the funds will be deposited. In some instances, a currency may be chosen by default, such as to be the domestic currency. A user selection of currency may override the default currency selection.

The card 100 may have other features. For example, a user may be able to select the card's expiration date. In another example, a user may be able to select the card number, or a portion of the card number.

The card 100 may display the selected customizable features 120. Each customizable feature 150 may be represented by an image, symbol, alphabet, other text, other graphic, or combination thereof. For example, a card having five customizable features 150 may be represented by five distinct images, symbols, text (e.g., string), or graphic. The card may display a currency of the card as a currency symbol (e.g., $, etc.) In some instances, the customizable features may be represented by a code, such as a QR code or other code. In some cases, a single code may exist for each customizable feature. In other cases, a single code may encode all or a group of customizable features. The code may be read, interpreted, and/or otherwise analyzed by a user device. The user device can be a personal user device (e.g., mobile phone, smart phone, personal computer, laptop, desktop, tablet, etc.). The user device can be a barcode scanner, optical scanner, camera, or other devise having an optical sensor and a processor capable of reading or scanning the code. The user device can be communicatively coupled (e.g., integrated, wireless or with wired connection to an external device, etc.) such an optical sensor and/or processor capable of reading or scanning the code. The selected customizable features 120 may be printed on the card 100. The selected customizable features 120 may be embossed, embedded, and/or otherwise imprinted on the card 100. Beneficially, a user in possession of the card 100 may be able to check or confirm, at any time, the features of the particular card 100. This may be particularly advantageous for users having multiple cards where it is hard to keep track of, or remember, the features of each card.

One or more features may be selected at the time the card 100 is created. In some instance, the one or more features may be modified after card creation. For example, a feature may be added or removed. In some instances, the one or more features may be modified within a certain time window after card creation, such as within 1 day, 3 days, 1 week, 2 weeks, 3 weeks, 1 month, 2 months, 3 months, 4 months, 5 months, 6 months, 1 year, etc. In some instances, the one or more features may not be modified once selected for a card. In some instances, aspects of a feature (e.g., shared users for the shared feature) may be modified. In some instances, the one or more features may not be modified once a card expires (e.g., after single load). In some instances, an expired card may be revived by modifying the one or more features (e.g., converting a single load feature to a reloadable feature). In some instances, upon modification of one or more features on the card, the system may prompt the user to provide additional information, such as personal information (e.g., required to create a debit and/or savings account, required to perform a credit evaluation, etc.), depending on the requirements associated with the one or more features modified. In some instances, upon modification of one or more features of the card, the system may remove information (e.g., personal information) if the information is no longer needed based on the new selection of features (e.g., removable of the savings feature would obviate the need for information required to create a savings account). In some instances, upon modification of one or more features of the card, the system may create and/or terminate one or more accounts based on the new selection of features (e.g., removable of the savings feature would obviate the need for a savings account).

When one or more features are modified, a new card can be printed and/or issued to the user, to display the updated selection of the customizable features.

In some instances, each feature may be associated with a monthly fee for using the card feature. In some instances, each feature may be associated with a flat fee (e.g., paid once) for purchasing the card feature until card expiration. In some instances, any combination of features may be available for selection for the same monthly fee for using the card. In some instances, any combination of feature may be available for selection for a flat fee (e.g., paid once) for the card.

Advantageously, the payment systems, methods, and devices described herein allow a user to customize the functionality of a card by selecting one or more customizable features. The user may be able to combine different functionalities to customize a card to meet precise personal needs, instead of for example taking a card with a pre-existing bundle of features off the market that might not necessarily include all the features that the user desires (or includes features that the user has no need for). Furthermore, a user may be able to modify the one or more features of the cards as the personal needs change or evolve over time. A user, or a plurality of users, may be able to achieve significant flexibility in creating and using a payment system.

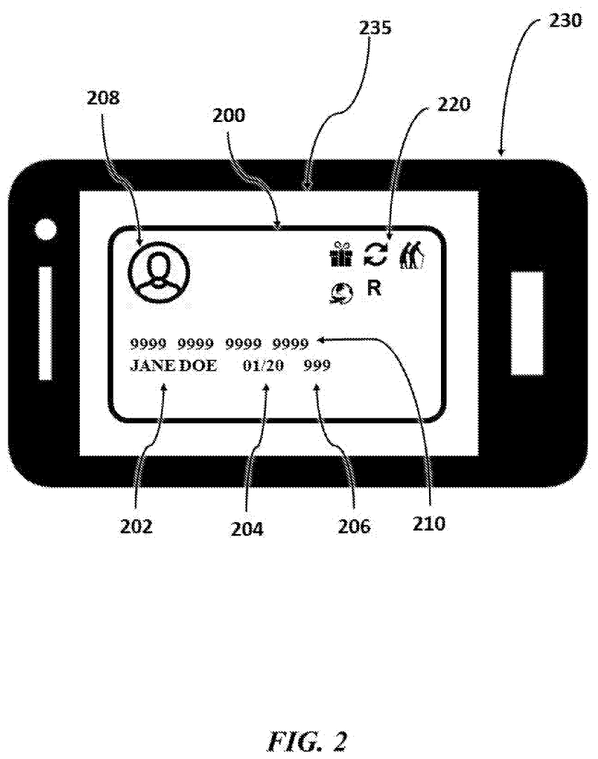

FIG. 2 shows an example of a virtual card-based payment system with selectable features. A card 200 can be a virtual prepaid card. The card 200 may or may not have a unique financial account (e.g., bank account) associated with the card 200. In some instances, a plurality of cards (e.g., including the card 200) may be associated with the same financial account. In some instances, the card 200 may be associated with a plurality of financial accounts. The card 200 may be accessed via a user device 230, such as through a graphical user interface 235 or web-based interface. The user device 230 can be a personal device, such as a computer, laptop, desktop, tablet, mobile phone, smart phone, or any other user device. The user device 230 may be a mobile device. The user device 230 may have a user interface capable of receiving input. The user device 230 may be communicatively coupled to a display. For example, the display can be integrated in the user device 230 or external to the user device 230 and coupled to the user device 230 via wired or wireless (e.g., Wi-Fi, Bluetooth, Near Field Communication (NFC), radio frequency, etc.) methods. The display may show a graphical user interface (GUI) 235 and/or a web-based interface.

The user device 230 may comprise one or more geolocation sensors capable of detecting a user's location, such as via triangulation or similar methods. The user device may have a Global Positioning System (GPS) position sensor, or other global navigation satellite system (GNSS) sensors. The user device may be capable of using radio waves, magnetic fields, acoustic signals, or other sensory information to detect a user's location. The detected user location may be used to, for example, determine a currency of a card transaction, a default currency during creation of a card, and/or supply KYC information for the user.

The GUI 235 may display a graphical representation of the card 200. The graphical representation of the card 200 may be two-dimensional (2D) or three-dimensional (3D). The graphical representation of the card 200 can have standard card dimensions, for example, complying with international standards (e.g., ISO/IEC 7810). For example, the card can be displayed to have 85.60 millimeters (mm) in length, 53.98 mm in width and 0.76 mm in thickness. The card can be displayed to have the above proportions. Alternatively, the card can be displayed to have any size. Preferably, the card graphic can fit in the display of the user device.

In some instances, the virtual card 200 can be associated with a tangible card (e.g., card 100). The virtual card 200 may, for example, be a graphical representation of the tangible card. The virtual card 200 may not be associated with a tangible card. In some instances, the user may request a tangible card associated with the virtual card 200, and the tangible card can be created and/or issued upon the request.

The virtual card 200 may have corresponding features to the card 100 described with respect to FIG. 1.

The card 200 may have one or more security identification features 208. The security identification features 208 can be, for example, a picture of the owner of the card 200. The security identification features 208 can comprise any other graphic, such as a photo, picture, symbol, image, and/or combination thereof. The security identification features 208 can comprise text, such as a name or nickname of the card 200 and/or the owner of the card 200. The security identification features 208 can comprise both graphic and text. The security identification features 208 may provide validation or verification regarding proper ownership of the card. For example, the security identification features 208 may allow for the verification of the user of the card 200 as someone or some entity having authority to use the card 200 (e.g., at a vendor). The security identification features may facilitate identification of the card 200 to the owner, user, and/or manager of the card 200. The one or more security identification features 208 may be displayed on the card 200. Alternatively, the card 200 may not have any security identification features 208. Any of the features mentioned herein, such as described above or further below, may be on the front side and/or back side of the card 200. A user may be able to view a graphic representation of the back side of the card 200, such as by providing a user command to the user device 230.

The card 200 may have a name 202 of the user, owner, and/or manager of the card 200. The name 202 may be displayed on the card 200. The card 200 may have an expiration date 204. The expiration date 204 may be displayed on the card 200. The card 200 may have a card verification value (CVV) 206 or other security code of the card 200. The CVV 206 may be displayed on the card 200. The card 200 may have a card number 210 or other security code of the card 200. The card number 210 may be displayed on the card 200.

A user may customize one or more features on the card 200. A user can be an owner of the card 200. A user can be a creator of the card 200. A user can be a recipient of the card 200. A user can be any individual or entity, or group of individuals or group of entities, managing, using, and/or otherwise controlling the card 200 by at least some amount. The customizable features can be, for example, the features 150 described above with respect to FIG. 1.

The one or more customizable feature can be selected by the user, for example, on the graphical user interface 235 of the user device 230. In some instances, each of the customizable features available for selection can be displayed to the user as a graphical and/or text representation from an option menu. A user may select a feature by providing a user command (e.g., clicking, touching, tapping, double-clicking, double-tapping, swiping, dragging, drag-and-drop, pinching, etc.) with respect to the graphical and/or text representation of the feature. A feature may appear on the card 200 as graphical representations 220 upon selection. Any selection and/or modification of one or more customizable features associated with the card 200 can be displayed on the card in real-time. Real-time, as used herein, can refer to a response time of less than 1 second, a tenth of a second, a hundredth of a second, a millisecond or less. Alternatively, real-time can have a response time of more than a second. Real-time can also refer to a simultaneous process or reflection of a real state.

A method for virtual card creation may comprise presenting a user with a visual representation of a virtual card and an option menu with graphical and/or text representations of a plurality of customizable features, receiving a user command for a selection of a subset of the plurality of customizable features, and displaying the respective graphical representations of the subset of the plurality of customizable features on the visual representation of the virtual card. In some instances, the visual representation of the card may be updated with each selection of a customizable feature to show the graphical representation of the customizable features. In other instances, the visual representation of the card may be updated after a plurality of selection of a subset of customizable features to show the graphical representations of the subset. A user may modify the selection, such as adding or removing one or more customizable features. In some instances, the visual representation of the card may be updated with each modification to show the addition or removal of the graphical representation of the customizable feature. In other instances, the visual representation of the card may be updated after a plurality of modifications are made. For example, a user may manually command the graphical update (e.g., via a “refresh” button). In another example, the update may be made automatically without user input. In some instances, the method may further comprise prompting the user for commands on setting or modifying another visual parameter of the virtual card or an element thereof (e.g., name, card number, card display, etc.), such as color, size, shape, background image, or form, and upon receipt of such commands, updating the display to show the graphical change on the visual representation of the virtual card. In some instances, the method may further comprise prompting the user for commands on setting or modifying a card balance display mode, such as to show or hide available balance, change a type of balance shown (e.g., amount spent, amount remaining, rewards collected, rewards spent, etc.), the number of card balances, and the like. Card balance displays are described elsewhere herein in further detail.

A virtual payment system may provide a number of advantages. For example, any change with the virtual card 200 can be effected in real-time. A card may be created almost instantaneously upon selection of the one or more customizable features. A new card need not be created and/or issued with the modification of one or more features because the changes can be registered within the system near instantaneously upon selection. Substantial resources, such as card material, time (e.g., shipping or mailing time, production time, etc.), and labor can be saved. For example, gift cards may be easily gifted to another user. For example, for shared cards, allowance cards, and/or elder support cards, the cards may be easily duplicated amongst the involved users.

Communication between shared users can be facilitated, such as by integrating a communications platform with the virtual card payment system Communication between supporting and supported users can be facilitated, such as via the communications platform. Requests between users may be made via the virtual card payment system (e.g., via the communications platform). Modifications to a user's level of control to a card may be effected near instantaneously upon command. Related features, such as viewing transaction histories for a card, can be integrated in the virtual card payment system.

In some instances, users may receive notifications on the user device via the virtual card payment system for any card-related activity (e.g., remaining balance, transaction initiation, transaction failure, etc.).

In some instances, a user may access the virtual card 200 on multiple user devices, such as by associating the virtual card 200 to a user account accessible from the multiple user devices (e.g., via user credentials, via phone number, via biometric authentication, etc.).

A virtual payment system may also provide more security—the virtual card 200 may have electronic security features associated with access of the virtual card. For example, the electronic security features can be user credentials associated with a user account required to access the virtual card. The user credentials can involve a user name and password. The user credentials can involve a PIN. The user credentials can involve biometric authentication, such as facial recognition, fingerprint, ocular recognition (e.g., via iris patterns), voice recognition, gait recognition, gesture recognition, and other authentication involving an individual's unique biological features or bodily movement. The user credentials can involve a pattern. The user credentials can involve a token, such as uniquely associated with a user account and provided to the user. The token may generate one-time passwords (OTPs). In some instances, the system may require such user authentication, or at least a reduced form of authentication, for each use of the card 200. Beneficially, the virtual card 200 may not be stolen without also stealing the user device and/or user credentials or other security features (e.g., PIN, password, biometric authentication, etc.) associated with the virtual card 200.

The virtual card 200 may allow for convenient provision of various complementary features and services to the use of the virtual card 200. For example, the available balance on the card may be viewed in real-time. In another example, the transaction history of the card may be viewed in real-time. A user may view a transaction history on a per-transaction basis. A user may view a transaction history as part of a billing statement or other periodic report.

In another example, the system may provide a spending analysis based on usage of the card 200. In some instances, the user may have a plurality of virtual cards associated with a user account with the system, and the system may provide a comprehensive spending analysis based on usage of all of the cards associated with the user account. The spending analysis can be temporal, and presented with respect to different time segments. The spending analysis can be categorical, and presented with respect to different categories (e.g., shopping, income, rent, auto, entertainment, food, etc) of spending. The spending analysis can be both temporal and/or categorical.

In another example, the system may provide alerts and notifications based on usage of the card 200. The alerts and notifications can be an in-application notification, such as provided by the virtual payment system. The alerts and notification can be in the form of e-mail, text, and/or phone call. The alerts and notifications can notify the user on regular or irregular activity, such as on regular purchase activities, deposits received, a balance below a predetermined threshold, or suspicions of fraudulent activity. The alerts and notifications can notify the user of the availability of a monthly report or other report (e.g., spending analysis report, billing statement, etc.).

In another example, the system may provide customer service. The customer service may facilitate communications between a customer service agent and a user via a communications platform integrated with the system. For example, the communications platform can be an instant messaging platform directly connecting each user of the system to an available customer service agent.

The aforementioned features and services may also be provided with tangible cards (e.g., card 100).

The cards of the present disclosure, such as tangible or virtual prepaid cards, can be loaded with funds by a number of methods, some of which have been described earlier. For example, a card may be loaded via a user providing cash, such as to a retail partner of the payment system, an automated teller machine (ATM) in communication with the payment system, agents (e.g., money agents) of the payment system, or other intermediaries between the user and the payment system, who (or which) on behalf of the user can load funds onto the card. The user may provide the card identification information (e.g., card number) to the intermediary (e.g., retail partner, ATM, agent, etc.) with the cash. For example, the user may temporarily provide the tangible card (which can be swiped or otherwise recognized by the intermediary). In another example, the user may provide the virtual card information (e.g., via wired or wireless transmission of information which can involve, for example, codes (e.g., QR codes, barcodes, etc.), Wi-Fi, Bluetooth, NFC, MST, wireless magnetic communication (WMC), etc.). The intermediary may also manually enter the card identification information into the system. In another example, a card may be loaded via wire transfers (e.g., through ACH, on-us transfers, other banking networks). In another example, a card may be loaded via direct deposit, such as described above. In another example, a card may be loaded via check-cashing. In another example, a card may be loaded via mobile wallet applications. A card may be loaded via P2P transfer, such as from a financial account or another card.

The cards of the present disclosure can be used at a point-of-sale via a number of methods. For example, a tangible card may be swiped. A tangible card may have contactless payment technology integrated in the tangible card. For example, the tangible card may have a smart chip or smart card integrated in the tangible card. The tangible card may have one or more circuits capable of transmitting and receiving radio frequency integrated in the tangible card. Such tangible cards may be tapped, contacted, or otherwise brought in proximity to a payment processing machine (e.g., payment terminal) to process a fund transfer. A virtual card may be used via, for example, Near Field Communication (NFC) and/or Magnetic Secure Transmission (MST) technology. An existing mobile wallet using such NFC and/or MST technology can be used (e.g., Android Pay®, Apple Pay®, Samsung Pay®, etc.). Alternatively or in addition, other wireless technology, such as Bluetooth or Wi-Fi, may also be used.

The cards of the present disclosure can be used for P2P transfers. For example, a card may be an origin and/or recipient of a P2P transfer. Funds may be transferred from a financial account (e.g., bank account) to a card. Funds may be transferred from a card to a financial account. Funds may be transferred from a first card to a second card. In some instances, funds may be transferred to or from a financial account associated with a card P2P transfers may be facilitated via one or more third party services (e.g., Venmo®, Paypal®, Square®, etc.). P2P transfers may be facilitated directly via one or more networks, such as an ACH system. In some instances, where funds are transferred within the same financial institution (e.g., between different accounts in the financial institution), the transfer can be an on-us transfer that can take significantly less time. Fund transfers can be international (e.g., over SWIFT network, etc.)

Funds from the cards of the present disclosure can be withdrawn by a number of methods, some of which have been described earlier. For example, a card may be withdrawn as cash via ATM networks in communication with the payment system, a retail partner of the payment system, agents (e.g., money agents) of the payment system, or other intermediaries between the user and the payment system, who (or which) on behalf of the user can withdraw funds from the card. The user may provide the card identification information (e.g., card number) to the intermediary (e.g., retail partner, ATM, agent, etc.). For example, the user may temporarily provide the tangible card (which can be swiped or otherwise recognized by the intermediary). In another example, the user may provide the virtual card information (e.g., via wired or wireless transmission of information which can involve, for example, codes (e.g., QR codes, barcodes, etc.), Wi-Fi, Bluetooth, NFC, MST, etc.). The intermediary may also manually enter the card identification information into the system. In another example, funds may be withdrawn via wire transfers (e.g., through ACH, on-us transfers, other banking networks). In another example, funds may be pulled from the card, such as via automated billing. In another example, funds may be withdrawn as checks. In another example, funds may be withdrawn via mobile wallet applications. Funds may be withdrawn via P2P transfer, such as to a financial account or another card.

Further provided herein are visual systems, devices, and methods for facilitating card transactions. A user may be provided with a display of the balance of available financial credit on a card associated with such financial credit, such as available credit on a credit card, available account balance on a debit card, available prepaid balance on a credit card, available rewards or points balance on a rewards card, and/or other types of financial credit on other types of cards. The balance on the display may reflect a real available balance of the card. The display can be integrated m the card. The display can be a user interface, such as a graphical user interface (GUI). The available balance on the display can be updated periodically or manually, such as with each card transaction. The available balance on the display can be updated, such as via connection with a device, such as a mobile device, other personal device, or purchase processing device.

The card may be a tangible card, such as in the form of plastic material or other type of material (e.g., metal, non-metal, rubber, etc.). The card may be a virtual card that is accessible via one or more user devices via a user interface. For example, the user interface can be a graphical user interface (GUI) and/or a web-based interface. In some instances, the descriptions herein may apply to another payment system that carries or otherwise can access financial credit.

The available balance of a card may change with a card transaction. A card transaction may involve any fund transfer described herein (e.g., a payment, a bill payment, a gift, a refund, a P2P transfer, a direct deposit, etc.). In some instances, the card transaction may involve a rewards or points transfer, such as for a rewards card. In some instances, the card transaction may involve any transfer of financial credit.

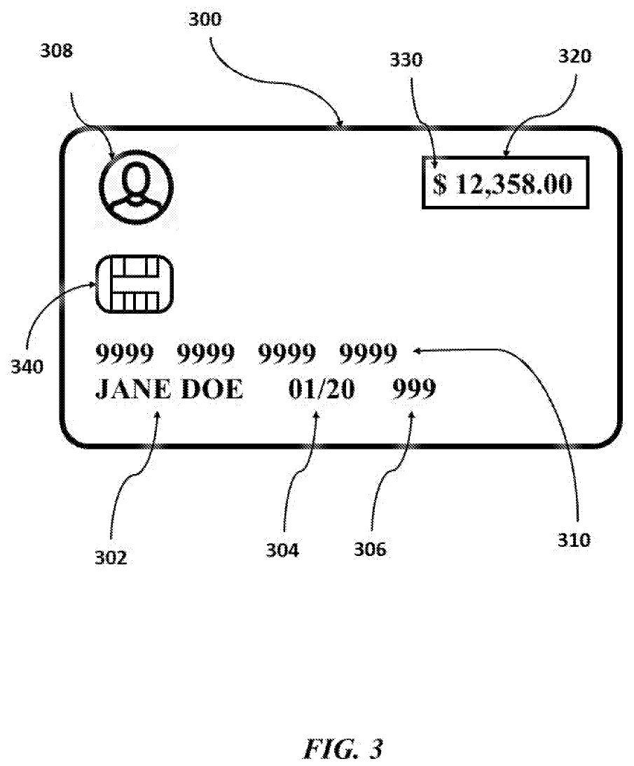

FIG. 3 shows an example of a card with a display. A card 300 can be a prepaid card, credit card, debit card, gift card, rewards, card, or any other type of card. The card 300 may or may not have a unique financial account (e.g., bank account) associated with the card 300. In some instances, a plurality of cards (e.g., including the card 300) may be associated with the same financial account. In some instances, the card 300 may be associated with a plurality of financial accounts.

The card 300 can have standard card dimensions, as described elsewhere herein. Alternatively, the card can have any size. Preferably, the card can fit in a wallet or purse.

The card 300 may have one or more security identification features 308, as described elsewhere herein. Alternatively, the card 300 may not have any security identification features 308. Any of the features mentioned herein, such as described above or further below, may be on the front side and/or back side of the card 300. FIG. 3 shows an exemplary front side of the card 300 comprising the security identification features 308.

The card 300 may have a name 302 of the user, owner, and/or manager of the card 300, as described elsewhere herein. The card 300 may have a card number 310 or other identification code of the card 300. For example, the identification code can be a barcode (e.g., quick response (QR) code, one-dimensional (1D) code, two-dimensional (2D) code, three-dimensional (3D) code, graphical codes, textual codes, etc.). Any of the abovementioned features or any other feature on the card, such as the name, expiration date, CVV, and/or security features may be displayed as one or more barcodes or other type of codes on the card.

The card 300 can be a smart card (e.g., embossed cards, magnetic stripe cards, memory cards, optical memory cards, microprocessor cards, cryptographic coprocessor cards, contactless smart cards, contact cards, etc.). The card 300 may comprise a chip 340. The chip can comprise an electronic memory. The chip may comprise an integrated circuit (IC). The chip may comprise a microprocessor and/or microcontroller. For example, the chip can comprise a microprocessor with memory. The chip can comprise a memory circuit. By way of example, the chip may be a silicon chip mounted on a glass substrate with gold plated connectors. The chip may be integrated in the body of the card 300 (e.g., card substrate). The card substrate can be, for example a PVC- or polyester-based card. The card substrate can be any other material.

The card 300 with the chip 340 may communicate with an external processor via a card reader or other intermediary card reading (or scanning) device. The card reader can be in communication with the external processor (e.g., bank server, computer, etc.) via wired or wireless technology (e.g., Wi-Fi, Bluetooth, Near Field Communication (NFC), Radio Frequency (RF), etc.). The communication may or may not be over a network. Via the IC in the chip 340, the card 300 can communicate with the card reader directly or indirectly using radio frequency (RF) communication technology. The card reader can be a contact or contactless reader. A contact smart card, read by a contact reader, can comprise electrical contacts on the chip 340 to connect to the card reader where the card is inserted and contacts the card reader. For example, the electrical contacts can be located on a conductive gold plated coating on the card surface. A contactless smart card, read by a contactless reader, can comprise an antenna which utilizes RF bands with an antenna on the contactless card reader. The antenna may be included in the chip 340 and/or otherwise integrated on the card substrate. In some instances, the chip 340 may be powered by electromagnetic signals received from the card reader. In some instances, the chip 340 may be powered by an internal battery. The internal battery can be electrically coupled to the antenna and/or chip 340.

A smart card can be a memory card, comprising a memory circuit and capable of storing, reading, and writing data. In some instances, the memory card may not process or manipulate data. The memory card can be a storage memory card. The memory card can be a protected memory card with restricted access. A smart can be a microprocessor-based card, comprising a microprocessor embedded on the chip 340, and capable of processing and/or manipulating data.

The card 300 may comprise a display 320 in electrical communication with the chip 340. The display 320 can be a display window. In some embodiments, the chip 340 may neighbor the display. The display can be a graphical user interface. The display can be a light-emitting diode (LED) display. The display may be capable of showing (or discerning) different numbers (e.g., 0, 1, 2, 3, 4, 5, 6, 7, 8, 9). In some instances, the display may be capable of showing different currencies 330. In some instances, the display may be capable of showing different punctuations (e.g., ‘.’, ‘,’; ‘;’, etc.) used to display a balance. In some instances, the display may be capable of showing different alphabets or characters of one or more languages. In some instances, the display may be capable of showing any graphic (e.g., image, symbol, picture, etc.).

In some instances, the display 320 can be a static display. In some instances, the display 320 can be a dynamic display. For example, where a displayed balance is too long relative to the width (or length) of the display 320, the balance value displayed may scroll horizontally and/or vertically. The scrolling can be in any other direction. The display 320 may show content at all times, for example, so long as it is powered. Alternatively, the display 320 may show content when triggered, such as upon initiating a card transaction. Alternatively, the display 320 may be triggered via one or more user interactive objects (e.g., buttons, switch, etc.) that can be manipulated by a user. The display 320 may be triggered via one or more sensor-connected values (e.g., intensity of lighting, movement of the card, vibration of the card, audio commands, etc.), such as via one or more sensors (e.g., camera, gesture sensors, microphones, etc.) operatively connected to the display. In some instances, the display 320 may be triggered via biometric authentication (e.g., involving one or more biometric sensors operatively coupled to the display). In some instances, the display 320 may be triggered when a card transaction is approved (e.g., correct input of PIN, etc.). Beneficially, the contents of the display 320 can be protected. Furthermore, power used to power the display 320 can be saved. In some instances, the display 320 may be powered by electromagnetic signals and/or radio frequency signals from a card reader. In some instances, the display 320 may be powered by an internal battery electrically connected to the display 320 and/or the chip 340.

The display 320 may show the available balance of financial credit associated with the card. For example, the available balance can be a credit balance on a credit card, a prepaid balance on a prepaid card, an account balance of a financial account associated with a debit card, or a rewards or points balance on a rewards card. In some instances, the display 320 may show an amount spent. In some instances, the display 320 may show a percentage available or a percentage spent. In some instances, the display 320 may show a number of card transactions, a number of card transactions required until a next reward, a number of valid card transactions, rewards, or purchases left on the card, or any other number. In some instances, the display 320 may show a different value, such as an expiration date of the card, a card number, a name of the owner of the card, and other numerical or textual value associated with the card.

The contents (e.g., available balance, rewards, etc.) of the display 320 of the card 300 can be updated periodically or manually, such as with each card transaction. For example, during a card transaction, when the chip 340 communicates with the card reader via contact or contactless methods, described elsewhere herein, the card reader may obtain, in real-time, the updated balance on the card 300, such as from a banking server, and transmit such updated balance to the chip 340, which can be shown on the display 320 (automatically or upon being triggered by a user or by other actions). Real-time, as used herein, can refer to a response time of less than 1 second, a tenth of a second, a hundredth of a second, a millisecond or less. Alternatively, real-time can have a response time of more than a second. Real-time can also refer to a simultaneous process or reflection of a real state. In some instances, the balance can be updated on the card 300 anytime the card 300 communicates with a card reader. In some instances, the chip 340 may comprise instructions in memory to request an updated balance from a relevant server (e.g., banking server, any other server of a financial institution or other administrator associated with the card, a server of a vendor for rewards information, etc.). As will be appreciated, the same methods may apply to any other type of content (e.g., rewards, expiration date, etc.) that is shown on the display 320.

In some instances, the available balance on the display can be updated, such as via connection with another device, such as a mobile device, other personal device, or other purchase processing device. The communication can be via, for example, wireless technology such as NFC technology, Bluetooth technology, RF technology, or other wireless technology using the chip 340. The other device (e.g., mobile device, purchase processing device) may obtain the card content to be displayed on the display 320 from a relevant source (e.g., banking server, etc.), such as over a network (e.g., Internet, internet, extranet, intranet, etc.) and transmit such information to the chip 340. In some instances, the device (e.g., card reader, mobile device, etc.) may request user credentials (e.g., card PIN, user password, etc.) in order to access the information and/or transmit the information from the source to the card 300. In some instances, the device may be used by a user to customize content shown on the display 320, for example, such as allowing a user to select a type of information displayed (e.g., available balance, amount spent, rewards, expiration date, name, card number, etc.) or allowing a user to change the currency that the available balance is displayed in. The user may customize other graphical features, such as font, background color, and other graphics of the display 320.

The display 320 may be located on any part of the card 300, such as any corner, any quadrant, any side (e.g., front, back, etc) of the card. In some instances, the card 300 may comprise a plurality of displays. Each display may communicate with an independent chip (e.g., chip 340) on the card—the card 300 may have a plurality of chips. In some instances, a plurality of displays may be electrically connected to a single chip 340. Each display may display the same or different type of content.

Beneficially, a user having access to a tangible card 300 may have on-hand access to, via the display 320, relevant information associated with the card 300, such as an available balance of the card, available rewards accumulated on the cards, or any other information about the card, without having to separately confirm such information via other methods (e.g., logging into a web-based counterpart of the card, calling a customer service number, etc.) which can often be extremely inconvenient or entirely unavailable (e.g., when the user is off the grid or not connected to a network, such as the Internet or a telephone network) to the user. For example, a user who desires to use a prepaid card to purchase an item may be able to view the prepaid balance on the display 320 on the card 300 to determine if the prepaid card has sufficient balance to cover the cost of the item. In some instances, the display 320 can be used to display information that is otherwise permanently printed (e.g., imprinted, embedded, embossed) on the card (e.g., expiration date, etc) and allow the card to be recycled or reused without having to dispose of the card when such information expires, simply by updating the display 320 (and/or instructions on the memory of the chip 340).

The card 300 may comprise other visual features. In some instances, the card 300 may comprise one or more visual advertisements. The visual advertisements may be permanently printed on the card substrate. Alternatively or in addition, the visual advertisements may be displayed on the display 320. In some instances, the advertisements can be intermittently displayed with other content, such as between available balance, other advertisements, or other content described elsewhere herein. The display 320 may show more than one type of content, such as with a set display pattern or random display pattern. The advertisements, if shown on the display 320, may be periodically or manually (e.g., push from a vendor) updated upon communication with a device (e.g., card reader, mobile device), as described elsewhere herein.

The card 300 may further comprise the one or more customizable features 150 described elsewhere herein.

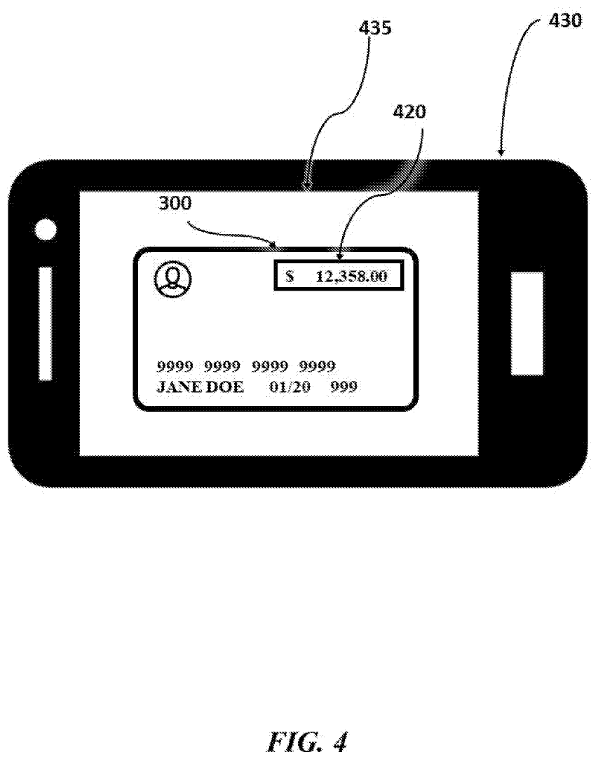

FIG. 4 shows an example of a virtual card with a display. A card 400 can be a virtual card. The card 400 may or may not have a unique financial account (e.g., bank account) associated with the card 400. In some instances, a plurality of cards (e.g., including the card 400) may be associated with the same financial account. In some instances, the card 400 may be associated with a plurality of financial accounts. The card 400 may be accessed via a user device 430, such as through a graphical user interface 435 or web-based interface. The user device 430 can be a personal device, such as a computer, laptop, desktop, tablet, mobile phone, smart phone, or any other user device. The user device 430 may be a mobile device. The user device 430 may have a user interface capable of receiving input. The user device 430 may be communicatively coupled to a display. For example, the display can be integrated in the user device 430 or external to the user device 430 and coupled to the user device 430 via wired or wireless (e.g., Wi-Fi, Bluetooth, Near Field Communication (NFC), etc.) methods. The display may show a graphical user interface (GUI) 435 and/or a web-based interface.

The user device 430 may comprise one or more geolocation sensors capable of detecting a user's location, such as via triangulation or similar methods. The user device may have a Global Positioning System (GPS) position sensor, or other global navigation satellite system (GNSS) sensors. The user device may be capable of using radio waves, magnetic fields, acoustic signals, or other sensory information to detect a user's location. The user device 430 may comprise one or more other sensors (e.g., cameras, microphone, gesture sensor, etc.) described herein.

The GUI 435 may display a graphical representation of the card 400, as described elsewhere herein (such as with respect to FIG. 2).

In some instances, the virtual card 400 can be associated with a tangible card (e.g., card 300). The virtual card 400 may, for example, be a graphical representation of the tangible card. The virtual card 400 may not be associated with a tangible card. In some instances, the user may request a tangible card associated with the virtual card 400, and the tangible card can be created and/or issued upon the request.

The virtual card 400 may have corresponding features to the card 300 described with respect to FIG. 3. For example, the card 400 may have one or more security identification features, name of the user, owner and/or manager of the card, expiration date, CV, card number, and other features displayed on the card 400. Any of the features mentioned herein, such as described above or further below, may be on the front side and/or back side of the card 400. A user may be able to view a graphic representation of the back side of the card 400, such as by providing a user command to the user device 430.

A user may use or manipulate the card 400 such as by providing a user command (e.g., clicking, touching, tapping, double-clicking, double-tapping, swiping, dragging, drag-and-drop, pinching, audio command, textual input commands, etc.).

The card 400 may comprise a card display 420. The card display 420 can be a card display window in the graphical representation of the virtual card 400. The card display 420 may be capable of showing any content described with respect to the display 320 of the card 300 in FIG. 3. In some instances, the card display 420 can be a static display. In some instances, the card display 420 can be a dynamic display. For example, where a displayed balance is too long relative to the width (or length) of the card display 420, the balance value displayed may scroll horizontally and/or vertically. The scrolling can be in any other direction. The display 420 may show content at all times. Alternatively, the display 420 may show content when triggered, such as via one or more user interactive objects (e.g., buttons, etc.) and/or user commands (e.g., tapping, clicking, etc.). The display 420 may be triggered via one or more sensor-connected values (e.g., intensity of lighting, movement of the card, vibration of the card, audio commands, etc.), such as via one or more sensors (e.g., camera, gesture sensors, microphones, etc.) operatively connected to the user device 430. In some instances, the display 420 may be triggered via biometric authentication (e.g., involving one or more biometric sensors operatively coupled to the user device). In some instances, the display 420 may be triggered when a card transaction is approved and/or certain information (e.g., user credentials) is provided by the user. Beneficially, the contents of the display 420 can be protected.

The content (e.g., available balance, rewards, etc.) of the display 420 of the card 400 can be updated periodically or manually, such as with each card transaction. In some instances, the user device 430 may communicate with a source of the content (e.g., banking server, etc.) to obtain the updated content and display such updated content on the card display 420. In some instances, the user device 430 may communicate with a card reader or other intermediary device that communicates with a source of the content to obtain the updated content and display such updated content on the card display 420. For example, the content may be updated at each time of card transaction (e.g., purchase, transfer, direct deposit, etc.). For example, during a card transaction, when the user device 430 communicates with the card reader via contact or contactless methods, described elsewhere herein, the card reader may obtain, in real-time, the updated balance on the card 400, such as from a banking server, and transmit such updated balance to the user device 430 which can be shown on the display 420 (automatically or upon being triggered by a user or by other actions). In some instances, the balance can be updated on the card 400 anytime the card 400 communicates with a card reader. In some instances, the user device 430 may request an updated balance from a relevant server (e.g., banking server, any other server of a financial institution or other administrator associated with the card, a server of a vendor for rewards information, etc.) periodically. As will be appreciated, the same methods may apply to any other type of content (e.g., rewards, expiration date, etc.) that is shown on the display 420.

The user device 430 or other device (e.g., mobile device, purchase processing device, card reader, etc.) may obtain the card content to be displayed on the display 420 from a relevant source (e.g., banking server, etc.), such as over a network (e.g., Internet, internet, extranet, intranet, etc.). In some instances, the user device 430 or other device (e.g., card reader, mobile device, etc.) may request user credentials (e.g., card PIN, user password, etc.) in order to access the information and/or transmit the information from the source to the card 400. In some instances, the device may be used by a user to customize content shown on the card display 420, for example, such as allowing a user to select a type of information displayed (e.g., available balance, amount spent, rewards, expiration date, name, card number, etc.) or allowing a user to change the currency that the available balance is displayed in. The user may customize other graphical features, such as font, background color, and other graphics of the display 420. The user may customize other graphical features of the card 400 in addition or alternatively to the card display 420.

The card display 420 may be located on any part of the card 400, such as any corner, any quadrant, any side (e.g., front, back, etc) of the card. In some instances, the card 400 may comprise a plurality of displays. Each display may display the same or different type of content.

Beneficially, a user having access to the virtual card 400 may have on-hand access to, via the display 420, relevant information associated with the card 400, such as an available balance of the card, available rewards accumulated on the cards, or any other information about the card, without having to separately confirm such information via other methods (e.g., logging into a web-based counterpart of the card, calling a customer service number, etc.) which can often be extremely inconvenient or entirely unavailable (e.g., when the user is off the grid or not connected to a network, such as the Internet or a telephone network) to the user. The virtual card 400 can be accessed while the user device 430 is offline (e.g., from a data network or telephone network). For example, a user who desires to use a prepaid card to purchase an item may be able to view the prepaid balance on the display 420 on the card 400 to determine if the prepaid card has sufficient balance to cover the cost of the item.

The card 400 may comprise other visual features. In some instances, the card 400 may comprise one or more visual advertisements. The visual advertisements may be displayed anywhere on the card. Alternatively or in addition, the visual advertisements may be displayed on the display 420. In some instances, the advertisements can be intermittently displayed with other content, such as between available balance, other advertisements, or other content described elsewhere herein. The display 420 may show more than one type of content, such as with a set display pattern or random display pattern. The advertisements, if shown on the display 420, may be periodically or manually (e.g., push from a vendor) updated upon communication with an advertisement server communicating with the user device 430. In some instances, the card 400 may display at least a portion of an advertisement before showing the substantive content (e.g., available balance) on the card 400. Beneficially (to an advertiser or a third party facilitating advertisement), a user of the card 400 is more likely to view the advertisement when it is displayed in the display 420. The card may further display graphical representations of one or more customizable features (e.g., graphical representations 220).

The examples provided herein can be applicable to any cards, such as prepaid cards, debit cards, reward cards, gift cards, and credit cards.

### Computer Control Systems

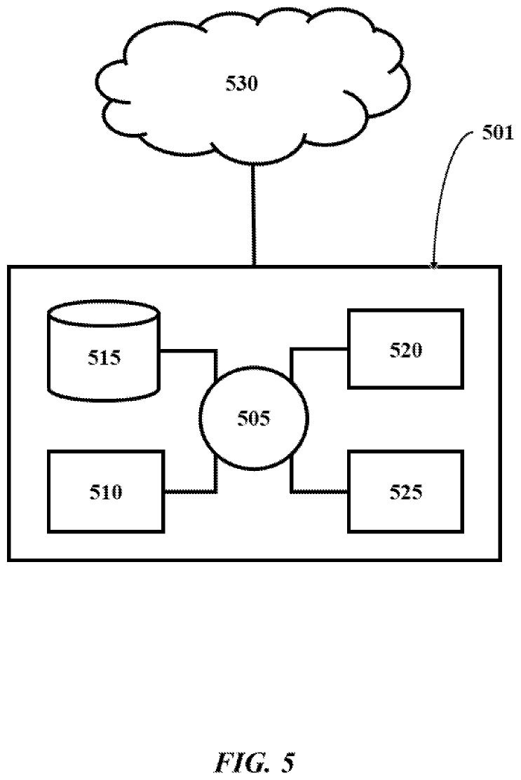

FIG. 5 shows a computer system 501 that is programmed or otherwise configured to implement systems, devices, and methods of the present disclosure. The computer system 501 can be linked, integrated with, and/or in communication with a card or payment system of the present disclosure. The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (e.g., solid lines such as a motherboard). The storage unit 515 can be a data storage unit (or data repository) for storing data. The computer system 501 can be operatively coupled to a computer network (“network”) 530 with the aid of the communication interface 520. The network 530 can be the Internet, an Internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user (e.g., account holder, cardholder, consumer, merchant, buyer, seller, financial institution, etc.). Examples of remote computer systems include personal computers (e.g., portable PC, desktop, laptop, etc.), slate or tablet PC's (e.g., Apple® iPad. Samsung® Galaxy Tab, etc.), telephones, smart phones (e.g., Apple® iPhone, Android-enabled device, Blackberry®, etc.), wearables, and/or personal digital assistants. The user computer system can be touch-enabled (e.g., touch phones, touch pads, touch screens, etc.). The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine have a processor adapted to execute the code, or can be compiled during runtime. The code can be supplied in a programming language that can be selected to enable the code to execute in a pre-compiled or as-compiled fashion. The code can comprise one or more algorithms configured to implement the systems, methods, and devices described herein.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium.

Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computers) or the like, such as may be used to implement the databases, etc. shown in the drawings. Volatile storage media include dynamic memory, such as main memory of such a computer platform. Tangible transmission media include coaxial cables: copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A virtual payment system, comprising a graphical user interface displaying a virtual card, wherein the virtual card comprises graphical representations of one or more customizable features selected by a user, wherein the one or more customizable features (i) define one or more financial capabilities of the virtual card, and (ii) are selected from the group consisting of: single-use, reloadable, international, domestic, direct deposit, reward, gift, shared, savings, elder support, and allowance.

2. The virtual payment system of claim 1, wherein the one or more customizable features can be modified.

3. The virtual payment system of claim 1, further comprising a tangible card associated with the virtual card, wherein the tangible card comprises the one or more customizable features selected by the user.

4. The virtual payment system of claim 1, further comprising a display window, wherein the graphical user interface is communicatively coupled to a processor capable of obtaining information about financial credit associated with the virtual card, and wherein the display window is configured to show the information about the financial credit associated with said virtual card.

5. The virtual payment system of claim 4, wherein the virtual card is a prepaid card and the information about the financial credit associated with the virtual card is an available balance of the virtual card.

6. The virtual payment system of claim 4, wherein the information about the financial credit associated with the virtual card is selected from the group consisting of available balance, amount spent, rewards accumulated, and rewards spent.

7. The virtual payment system of claim 4, further comprising a plurality of display windows, wherein each of the plurality of display windows shows a different type of information about the financial credit associated with the virtual card.

8. A method for creating a virtual card, comprising:
(a) presenting a user, on a graphical user interface, with a graphical representation of the virtual card and an option menu comprising graphical representations or textual representations or both of a plurality of customizable features, wherein the plurality of customizable features define the financial capabilities of the virtual card;
(b) receiving, from the user, a selection for a subset of the plurality of customizable features; and
(c) displaying the respective graphical representations of the subset of the plurality of customizable features on the graphical representation of the virtual card.

9. The method of claim 8, wherein the plurality of customizable features are selected from the group consisting of: single-use, reloadable, international, domestic, direct deposit, reward, gift, shared, savings, elder support, and allowance.

10. The method of claim 8, wherein the respective graphical representations of the subset of the plurality of customizable features are displayed on the graphical representation of the virtual card in real-time as the selection is received from the user.

11. The method of claim 10, wherein the graphical representation of the virtual card is updated in real-time with each selection of each of the subset of the plurality of customizable features.

12. The method of claim 8, further comprising receiving, from the user, a modification to the selection for the subset, and updating the graphical representation of the virtual card with the modification.

13. The method of claim 12, wherein the modification comprises adding or removing a customizable feature to or from the subset.

14. The method of claim 8, further comprising issuing a tangible card associated with the virtual card, wherein the tangible card comprises the subset of the plurality of customizable features.

15. The method of claim 8, wherein the graphical representation of the virtual card comprises a display window showing information about a financial credit associated with the virtual card.

16. The method of claim 15, wherein the virtual card is a prepaid card and the information about the financial credit associated with the virtual card is an available balance of the virtual card.

17. The method of claim 15, wherein the information about the financial credit associated with the virtual card is selected from the group consisting of available balance, amount spent, rewards balance, and rewards spent.

18. The method of claim 8, wherein the option menu further comprises options for setting or modifying one or more visual parameters of the virtual card or an element thereof, and the method further comprises receiving a user command for setting or modifying at least one visual parameter of the virtual card or the element thereof, and updating the graphical representation of the virtual card with the user command.

19. The method of claim 18, wherein the one or more visual parameters comprises colors, shapes, forms, background images, or sizes for the virtual card.

20. The method of claim 18, wherein the graphical representation of the virtual card is updated in real-time with receipt of the user command.
